(19) United States
(12) Patent Application Publication
(10) Pub. No.: US 2007/0281127 A1
(43) Pub. Date: Dec. 6, 2007

(54) Cordierite formation

(76) Inventors: Monika Backhaus-Ricoult, Horseheads, NY (US); Christopher Raymond Glose, Painted Post, NY (US)

Correspondence Address: CORNING INCORPORATED, SP-TI-3-1, CORNING, NY, 14831, US

(21) Appl. No.: 11/443,807

(22) Filed: May 30, 2006

(51) Int. Cl. C04B 35/195; C04B 35/03; C04B 35/04

(52) U.S. Cl. 428/116; 501/119; 264/631

(57) ABSTRACT

A process for making cordierite ceramic articles exhibiting improved properties involves steps of preparing a solution in which a sintering promoting agent is dissolved in a solvent prior to being combined with an alumina source, a silica source, a magnesia source, and an organic binder. The sintering promoting agent induces rapid growth of cordierite at lower temperatures and/or during shorter firing times, while preserving valued CTE and MOR properties. Improved MOR (MOR/E−mod*CTE) provide products exhibiting higher thermal shock resistance, and improved pore size distribution with cut off of smaller pore sizes providing products with lower back pressure at high filtration efficiency.

### FIELD OF THE INVENTION

This invention relates to the production of a highly porous cordierite ceramic articles for filter and substrate applications, and more particularly to an improved process and batch composition for making cordierite ceramic articles employing a sintering agent that provides a microstructure with improved product properties, while reducing at the same time firing time and/or temperature. The product made from the claimed batch has characteristics that are novel, high strength, low CTE and a narrow pore size distribution with a very small fraction of small size pores. The attributes of the novel product promise high thermal shock resistance (low thermal expansion, high fracture strength and low elastic modulus) and high filter efficiency at low backpressure (high porosity, narrow pore size distribution, high pore interconnectivity and smallest possible fraction of small pores).

### BACKGROUND OF THE INVENTION

Cordierite substrates, typically in the form of a honeycomb body, have been used for a variety of applications such as catalytic substrates and filters for diesel particulate emission. In order to respond to the increasingly restricting emission standards for light and heavy duty vehicles, the substrate materials have to be highly porous to allow gas flow through the walls without restricting the engine power, have to show high filter efficiency for emitted particles, and at the same time suffer no major pressure drop. The substrates also have to withstand the corroding environment and be able to stand thermal shock during rapid heating and cooling. Cordierite has low thermal expansion and is therefore suited for applications where high thermal shock resistance is required. Porous cordierite honeycomb ceramic articles can be made, which combine low thermal expansion coefficient, high porosity, low Young modulus and high strength, which are attractive for high-performance automotive catalyst converter and diesel particulate filter applications.

During the processing of shaped cordierite products, raw materials such as alumina, talc, clay, magnesia, alumina and silica are typically mixed with organic binders and pore formers. The plastic mixture is extruded or otherwise shaped into the desired form, known in the industry as a “green body.” The green body is dried and then fired to temperatures of about 1350° C. to about 1450° C., depending on the raw material combination. During the drying and firing process, the raw materials are converted, through various intermediates, into crystalline cordierite. The shaped piece of green ware transforms upon sintering into a solid, durable ceramic article.

Typically, shaping is achieved by extruding the mixed raw materials through a die. Extrusion leads to alignment of raw material particles and/or pore formers with platy shapes, such as alpha alumina, talc and graphite, and causes an anisotropic distribution of the viscous organic binder. During firing of the extruded material, cordierite forms on intermediate product particles (spinel, sapphirine) with its c-axis as the preferred growth direction. The cordierite grows by solid state reaction; it grows faster where a glassy phase is present. As a result, a highly textured material forms that is composed of radially grown domains. Each domain is composed of micrometer size grains with closely aligned c-axis. The size of the domains depends on nucleation and growth rates of cordierite, and on the quantity and distribution of glass phase. The misorientation between domains creates stresses during thermal cycling and leads to the formation of microcracks. These microcracks reversibly open and close during thermal cycling and thus reduce even more the already low intrinsic coefficient of thermal expansion (CTE) of cordierite.

Although cordierite products found application as automobile catalytic converters for over 30 years, it still remains desirable to improve the product quality and reduce manufacturing cost by reducing firing temperature (e.g., typical hold temperature of about 1400° C.) and time (typically in excess of 15 hours). For diesel particulate filters, the pore size distribution is a crucial property. Narrow pore size distribution and good connectivity between pores are required. It would be especially desirable to eliminate small pores with size below two micrometers to reach a lower pressure drop, while achieving the desired filtering effect.

Prior attempts to improve the pore size distribution, eliminate narrow pores, and provide better connectivity between pores have involved the use of new pore formers, different types of raw materials, including different particle sizes, and the use of different techniques for mixing the raw materials.

As suggested in U.S. Pat. No. 6,391,813, it is well known in the ceramics processing industry that sintering additives can be used to lower the sintering temperature and produce a more homogeneous microstructure with improved macroscopic properties. Most sintering additives form glasses at low temperatures and promote reaction and sintering through faster transport through a liquid or glassy phase. In a final stage of sintering, the additives distribute in the form of glassy pockets and grain boundary films in the ceramic. Even though the earlier and faster sintering in the presence of such glass forming additives is beneficial for reducing the firing temperature and time of cordierite products, second phases may raise the CTE, and thus lower the thermal shock resistance of the product. For this reason, sintering of cordierite in the presence of additives is usually not the preferred approach in large scale manufacturing processes.

Nevertheless, there has been continuous interest and research in developing sintering additives for production of cordierite ceramic articles. Such efforts and interests have mainly focused on developing sintering additives that reduce the firing time and temperature while maintaining a desirable CTE. It was demonstrated in the aforementioned patent that cordierite can be successfully obtained at temperatures below 1300 C. However, sintering additives have to our knowledge not been used as a lever to engineer well-defined microstructures with improved properties. Cordierite ceramics that were obtained in the past with sinter additives typically exhibited rather high CTE and an unsatisfactory ratio between strength of rupture (MOR) and elastic modulus. Thus the addition of solid boron oxide (B₂O₃) in concentrations up to two percent by weight to clay/talc batches had been observed to facilitate complete conversion to cordierite at temperatures as low as 1250° C., but the fired ceramic articles were reported to have higher CTEs than the boron-free product.

Accordingly, there remains a need for improved processing of cordierite ceramic articles in the presence of sintering agents that promote improved microstructures with high thermal shock resistance (low CTE, high MOR, low E-modulus), high filter efficiency and low backpressure (high porosity, narrow pore size distribution, high pore interconnectivity and small portion of small pores) and at the same time facilitate the complete conversion of the raw materials to cordierite at lower temperatures and/or during shorter firing times.

### SUMMARY OF THE INVENTION

One aspect of the invention provides a process for making cordierite ceramic articles. The process comprises steps of preparing a solution comprising a sintering promoting agent totally or partially dissolved in a solvent; preparing a cordierite forming batch comprising a magnesia source, an alumina source, and a silica source; mixing the solution, cordierite-forming batch, and an organic binder to obtain a plastic mixture; shaping the plastic mixture to form a shaped article; drying and heating the shaped article at a temperature and for a time effective to convert the shaped article to crystalline cordierite. The process advantageously requires lower heating temperatures and/or shorter heating times. Another aspect of the invention provides a batch composition with a sintering additive that produces a ceramic microstructure with improved properties: desirable CTE, much higher MOR, high porosity and a narrow pore size distribution without considerable contribution of pores with sizes below 1 micrometer, in most cases even 3 micrometer size.

### BRIEF DESCRIPTION OF THE DRAWINGS

FIGS. 1a and 1b present pore size distribution data for similarly fired ceramic parts from batches of differing B₂O₃ concentration.

FIG. 2 presents pore size distribution data (cumulative intrusion volume versus pore size) for a series of fired ceramic parts made from batches of differing B2O3 concentration and at different firing temperatures.

FIGS. 3a and 3b present pore size distribution data for fired ceramic parts made from batches of differing B₂O₃ content, fired to different peak temperatures within a firing range, FIG. 3b being plotted on a logarithmic scale to better illustrate B2O3 effects on the fraction of small size pores in the parts.

FIG. 4 presents transmission SEM images of polished cross-sections of fully fired ceramic parts made from batches of differing B₂O₃ concentration.

### DETAILED DESCRIPTION OF THE PREFERRED EMBODIMENTS

The invention employs the concept of homogeneously distributing a sintering aid in a cordierite-forming batch, wherein the sintering promoting agent is selected to consecutively (1) form at low temperature a hydrogel and/or hydrated oxide with very small pores that induce more homogeneous sintering and pore elimination during firing, (2) form at intermediate temperature a glass that eliminates small size pores and promotes more rapid formation of cordierite (thus also promoting shorter firing cycles and/or lower temperatures), and (3) partially to completely (depending on firing cycle) vaporizes at high temperature, thus yielding a product that combines the low CTE of additive-free materials with high MOR and pore network characteristics of additive-containing materials. Depending on the firing cycle, the product will exhibit high MOR/Young modulus and high pore connectivity. Examples of sintering promoting agents that may be employed with the invention include boron oxide and other boron containing compounds.

Other oxide additives that hydrate in aqueous medium and form with the batch components glasses with low eutectic temperatures are also expected to provide an improvement of MOR/Young modulus and pore connectivity. We observed such improvement in the presence of titania as additive.

It has been discovered that the homogeneous distribution of a suitable sintering promoting agent (e.g., boron oxide) in a cordierite-forming batch material, eliminates through controlled, promoted glass phase sintering the small size pores (capillarity effect) and reduces local stress concentration in the microstructure (smaller number of sites with high stress concentration and lower local stress in such sites due to stress relaxation during growth from glass phase), thus increasing the strain tolerance of the fired product (lower failure probability). In case of boron oxide as sintering promoting agent, boron oxide volatizes at high temperatures. For firing at higher temperature (about 1400 C), an almost pure cordierite product is obtained that has the same or improved properties as materials sintered without the sintering promoting agent (e.g., at a customary higher firing temperature and/or longer firing time).

It is believed that boron oxide forms a low temperature eutectic with alumina, magnesia, and silica. At lower firing temperatures, the low viscosity glass easily penetrates into the particle interspaces. The glass provides rapid transport paths for cations and oxygen, thus accelerating the solid state reaction rates for the formation of intermediate products and cordierite itself. This allows use of shorter firing cycles with lower maximum temperature. The presence of the glass phase diminishes the growth stresses cordierite crystals usually undergo when growing from solid phases. As a result, larger individual crystals can be grown, thus promoting low CTE. During cordierite formation, the stress between individual crystals is kept low by the presence of the intergranular glass. The glass decreases local stress concentration and number of sites with high concentration, diminishes the number of defects and flaws in the growing cordierite ceramic structure and thus increases the fracture toughness. In the process of sintering, small pores are overgrown once filled with the glass. As a result, the fraction of pores with sizes below three micrometer, often even five or ten micrometer, is much smaller (not existing) than in material obtained without any sinter additives. Filter efficiency and backpressure are expected to be improved. Additionally, the presence of boron oxide stabilizes the hexagonal indialite phase that has lower intrinsic CTE than cordierite, thus favoring once more lower CTE. Lower stress concentration in the microstructure, larger cordierite crystals, more hexagonal phase and suppression of small pores and defects are properties of the novel product that all contribute to an overall improvement in fracture toughness.

Insoluble or only partially soluble dopants or sinter additives usually form second phase glass films, glass pockets, or precipitates, and thus modify the CTE through both a modified microcrack density and a contribution of the intrinsic CTE of that second phase. The magnitude of the effect depends on quantity and distribution of the second phase. In the presence of a large quantity of borosilicate glass, the behavior is slightly different. More impurities dissolve readily in the borosilicate glass (e.g., calcium, titanium and iron), and, therefore less impurities go into the cordierite solid solution. When boron starts to evaporate at high temperatures in the firing process, the impurities concentrate in the remaining glass and, after complete boron evaporation, are left in very few, large size pockets, rather than forming a continuous or discontinuous grain boundary glass film or high densities of small precipitates that give rise to high local stresses due to CTE mismatch with the matrix, cause easier crack formation and contribute to part failure. Very few large glass pockets have only a small effect on the overall CTE and MOR of the material. Therefore, the final material obtained with boron oxide as sintering additive exhibits improved CTE and MOR compared to materials sintered without boron. Materials obtained without the sinter additive typically show significant decoration of high angle grain boundaries by glass and also contain small second phase precipitates.

Homogeneous distribution of the sintering promoting agent in the cordierite precursor composition is achieved by first partially or completely dissolving the sintering promoting agent in a solvent, such as warm or hot water. A suitable and preferred amount of boron oxide sintering promoting agent is an amount that provides between 0.3 and 5 percent by weight based on the total weight of the cordierite-forming batch on a dry basis. (The sinter additive is also active when added as powder, but less efficient.)

The plastic mixture that is shaped, dried and heated to make the cordierite ceramic articles of this invention comprises the solution containing the dissolved sintering promoting agent, a magnesia source, an alumina source, a silica source, and an organic binder. The expressions “a magnesia source”, “an alumina source”, and “a silica source” refer to magnesia, alumina and silica themselves or other materials, which when fired are sources of magnesia, alumina and/or silica. Suitable cordierite-forming magnesia sources, alumina sources, and silica sources are well known and will not be described herein. The mixture may also optionally include a pore former. A pore former is a fugitive particulate material, which evaporates or undergoes vaporization by combustion during drying or heating of the green body to obtain higher porosity and/or coarser median pore diameter than would be obtained otherwise. Pore former are used in an amount between 10% and 50% by weight based on the raw materials. Typically, graphite pore former may be employed in an amount of 10 to 40% based on the weight of the plastic mixture. As another option, starch pore former may typically be employed in an amount of from about 10% to 20% based on the weight of the plastic mixture. Pore formers with particulate size of at least 10 micrometers and not more than 50 micrometers are typically used.

The mixture is optionally mixed with a liquid, binder, lubricant, and plasticizer. Suitable organic binders, such as methylcellulose, ethylhydroxyethyl cellulose, hydroxybutyl methylcellulose, hydroxymethylcellulose, etc. are well known in the art and will not be described in further detail herein. If included, the sintering aid can be added as a powder or in liquid form to the mixture and further blended with the raw materials.

While the ceramic paste may be shaped by any ceramic forming method known in the art, such as injection molding, slip casting, dry pressing, the preferred shaping technique involves extrusion through a die. Such techniques may be employed for forming thin-wall honeycomb monoliths that are extremely useful for making automotive catalytic converters and particulate filters. Suitable extrusion techniques and other shaping techniques are well known in the art, and will not be described herein.

The resulting shaped green body is dried and then heated to a maximum temperature of about 1200° C. to 1500° C., more typically 1250° C. to 1450° C., over a period of about 2 to 200 hours, preferably 10 to 100 hours, and held at the maximum temperature for 1 to 100 hours, preferably 3 to 30 hours. The firing may be conducted in an electrically heated furnace or gas kiln. The partial pressure of oxygen in the firing atmosphere is preferably at least 0.01 atmospheres, and more preferably at least 0.10 atmospheres.

Although the ceramic substrate structure of the present invention can have any shape or geometry, it is preferred that the ceramic body of the present invention be a multi-cellular structure such as a honeycomb structure. The honeycomb structure has an inlet and outlet end or face, and a multiplicity of cells extending from the inlet end to the outlet end, the cells having porous walls. Generally honeycomb cell densities range from about 93 cells/cm² (600 cells/in²) to about 4 cells/cm² (25 cells/in²).

To further illustrate the principles of the invention, included are examples of the invention and comparative examples. It is to be understood that the examples are for illustrative purposes only, and are not intended to limit the scope of the invention. Various modifications and changes may be made in the invention, without departing from the spirit of the invention.

### EXAMPLES

The following section presents results on cordierite-forming batches that contain different levels of boron oxide. The results illustrate the potential of the invention. It shall, however, be understood that material composition and optimum firing cycle are interdependent.

TABLE 1
Examples of investigated types batch compositions:

| | | Pore Former |
|---|---|---|
| | Batch Composition | Content |
| A-batch | 14% Magchem 20, 35% C701, 51% Imsil A25 | 20% |
| B-batch | 40% FCOR, 15% C701, 14% Cerasil 300, 16% | 0-20% |
| | K10, 15% AC400, 4% F240, 16% Eml D | |
| C-batch | 40% FCOR, 22% C701, 16% FRF40, 22% | 10% |
| | silver bond | |

Table 1 gives examples of batch type compositions that were investigated with different levels of boron oxide sinter additive. The A-batch represents an oxide batch with alpha alumina, magnesia and silica which contains 20 percent graphite. Alpha alumina grade C701 from Alcan, magnesia grade Magchem20 from Marietta, silica grade IMSIL A25 from Unimin were used as raw materials. Graphite grade A625 from Ashbury with average particle size of about 30 micrometers was used as pore former. In clay-talc based compositions (type B batch), talc FCOR from Luzenac NA, clay K10 from Imerys, silica grade Cerasil 300 from Unimin were used. Talc-based batches (type C batch) contain besides the prior indicated raw materials aluminium hydroxide AC400 from Aluchem, FRF 40 from Alcan, Silverbond 200 from Unimin and Emulsion D (distilled water with triethanolamine from Acros Oranics and oleic acid for JT Baker). In some cases, mixtures of A-B and A-C batch types were used. All batches are mixed with F240 Methocel from Dow as organic binder; typically 3-5% of the batch weight is added. The typical content of water in the ceramic paste is between 30% and 50%; it is adjusted during mixing till providing extrudable texture. Reference batches that do not contain any boron oxide serve as reference for the corresponding batches with boron oxide additive. Between 0.3 and 2.5 weight percent B₂O₃ are added into the batch mixtures. The boron oxide powder is dissolved in warm water and added during mixing to the batch to ensure homogeneous distribution; in cases where the B₂O₃ does not completely dissolve in hot water (e.g., at 2.5 percent), any undissolved residue is added as a slurry. Some of the example batches contained in addition to the A-type batch a low content of sodium stearate.

Materials are extruded into honeycombs 200/18 (diameter 1″), dried at 70-90° C. in a manner that avoids rapid volatilization of water, and then fired. Higher residual boron oxide provides higher strength in the final product.

The various batches are fired in air with a heating rate of 2 C/min to a maximum temperature, hold at that temperature for 15 to 30 h and then cooled to room temperature with 2 C/min. The maximum temperature depended on the amount of boron oxide additive, being lower for higher boron oxide contents.

The fully fired ceramic parts contain less boron oxide than the green parts. The boron oxide content in the fired ware decreases with increasing soak time and temperature. The residual boron content as determined by ICP analysis in the fired ware is between 0.05 and 1.8% boron. Porosity of the listed material examples ranges between 30% and 55%, depending on raw materials, additive content, firing time and temperature.

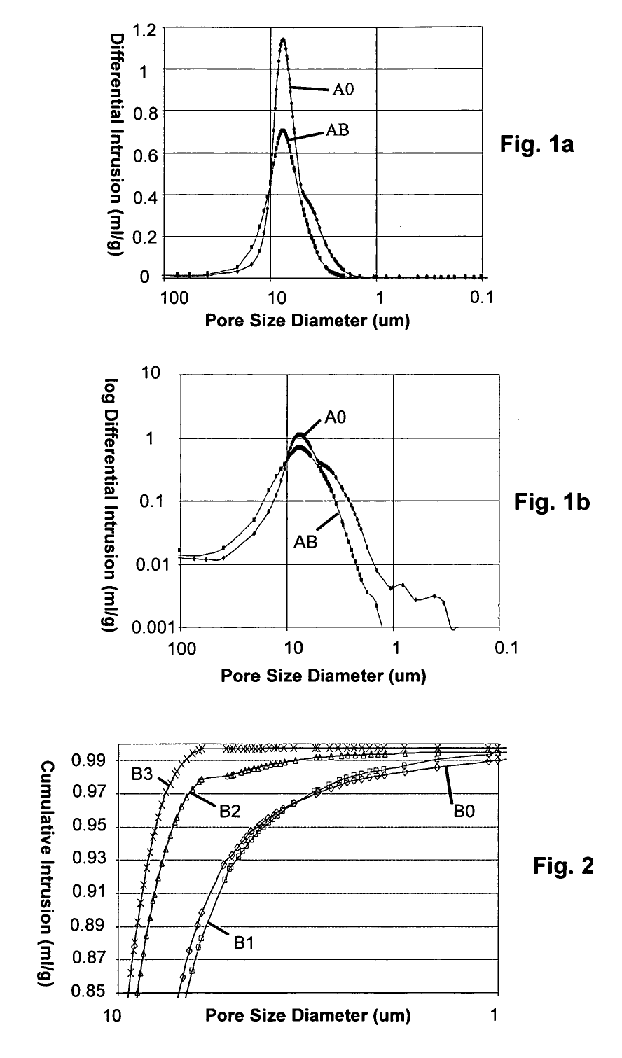

The appended drawings illustrate the effects of varying boron oxide batch additions and peak firing temperatures on the pores sizes and pore size distributions of the fired ceramic parts. FIGS. 1a and 1b are graphs of pore size distribution of 1″ parts of A-batch containing 0% (curve A0) and 2.5% of a B2O3 addition (curve AB) fired at 1430° C., 20 h, on arithmetic (FIG. 1a) and logarithmic (FIG. 1b) scales. The logarithmic plot (FIG. 1b) better illustrates the decrease of the fraction of small size pores. FIG. 2 is a graphical comparison of the pore size distribution (cumulative intrusion volume versus pore size) of 1″ parts of A-batch base composition containing 0% (curve B0), 0.3% (curve B1), and 1.5% B₂O₃ (curve B2) additions, all fired at 1430° C., for 20 hours. Data for a part of A-batch base composition containing 2.5% B₂O₃ and fired at 1400° C. for 20 h (curve B3) are also included.

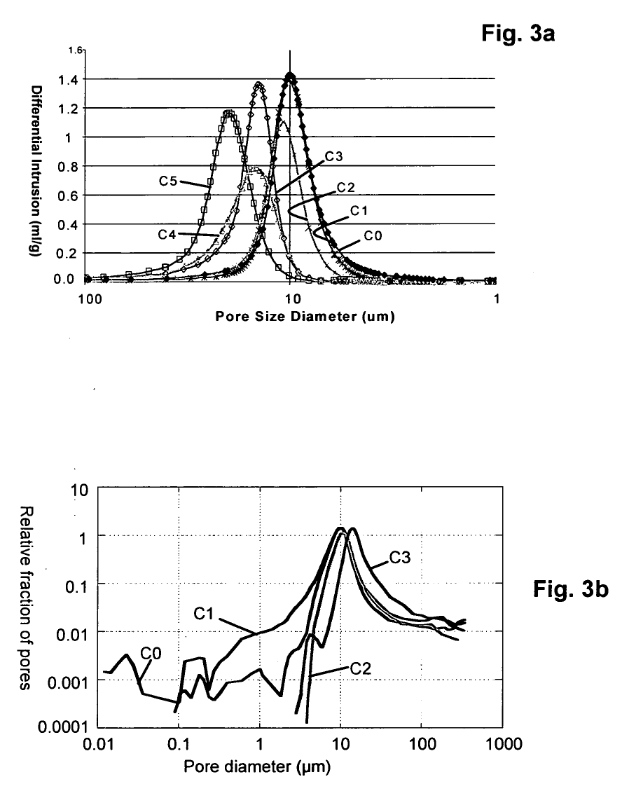

FIG. 3a is a graphical comparison of the pore size distribution of 1″ diameter parts of A-batch base composition containing 0% boron and between 1 and 2.5% B₂O₃ additions, fired at temperatures in the 1380-1430° C. range. The plots include curve C0—0% B₂O₃ fired at 1380° C.; curve C1—0% B₂O₃ fired at 1430° C.; curve C2—1% B₂O₃ fired at 1435° C.; curve C3—2% B₂O₃ fired at 1400° C.; curve C4—2% B₂O₃ with a small stearate addition fired at 1400° C.; and curve C5—2.5% B₂O₃ addition fired at 1380° C. FIG. 3b plots logarithmic pore size data for the samples of curves C0, C1, C2 and C3 to better illustrate the decrease of the fraction of small size pores accompanying the boron oxide additions.

As FIGS. 1-3 suggest, boron oxide additions shift the average pore size (d50) to slightly higher values and induces a slight broadening of the pore size distribution ((d50-d10)/d50). The most significant difference between ceramic parts made with and without boron oxide addition, however, is the contribution of small size pores. The number of pores smaller than one micrometer is decreased by a factor ten or more and even the fraction of pores smaller than three micrometers is still decreased by a factor of ten, see exemplary pore size distributions as obtained by mercury infiltration in FIGS. 1 and 3. The data plotted on the logarithmic scales demonstrate the average decrease of the small pore fraction by a factor of about 10 in materials having been processed with boron oxide addition compared to the corresponding boron-free material.

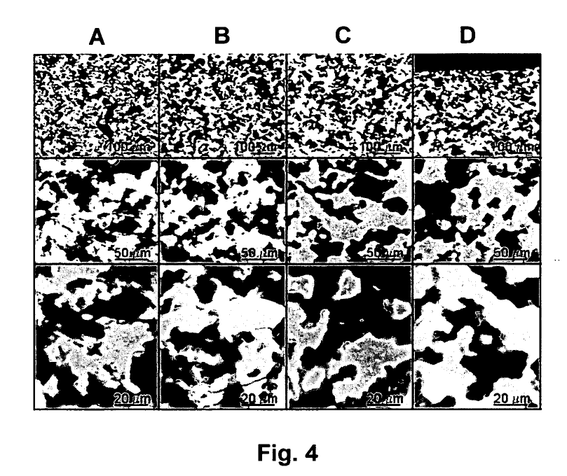

In presence of boron oxide additive, not only small pores disappear, the fraction of closed porosity also diminishes, and pore surfaces smoothen. The differences in the pore network of materials obtained with different level of boron oxide additive are illustrated in the scanning electron microscopy micrographs of polished cross sections in FIG. 4.

FIG. 4 consists of a series of transmission SEM images of polished cross-sections of fully fired A-batch ceramic parts containing 0%, 0.3%, 1.5 and 2.5% B₂O₃ (columns A, B, C and D from left to right as indicated, at increasing magnifications from top to bottom as indicated). All materials were fired for 10 h at 1430° C. The visually observed effects on the pore network are enhanced with increasing boron oxide addition. While the boron-free material shows a significant level of small size pores (and in addition often closed small size porosity), the minimum pore size in boron-containing materials is drastically decreased. The A-batch mixture sintered with 0.3 percent B₂O₃ shows no difference in its open porosity (typically greater than 40%) compared to the corresponding material fired without boron, but the fraction of closed porosity is lower. For higher boron oxide level, small pores with size of 2 micrometer diameter and below completely disappear. In materials obtained from oxide batches with 1.5 and 2.5 weight percent boron oxide, the minimum pore size is shifted to 5 and 10 micrometers, respectively. The effect is similar or even more pronounced in cordierite-forming batches with talc and clay or talc as additional raw material. For some compositions, the minimum pore size is around 20 to 30 micrometers. Those materials exhibit extremely little to no closed porosity. All data reflect a significantly decrease in minimum pore size in presence of boron oxide additive.

The I-ratios of the various materials after full firing show that preferential alignment of cordierite is obtained and that the alignment of cordierite does not suffer by the faster growth or growth at lower temperature in presence of the boron silicate glass. I-ratios are defined and described in U.S. Pat. No. 3,885,977.

Fully fired honeycombs (1″ diameter, cell geometry 200/18) show thermal expansion coefficients in the range of 3-15×10⁻⁷/° C., typically 8.5×10⁻⁷/° C. or less from 25° C. to 800° C., and even 5×10⁻⁷/° C. or less from 25° C. to 800° C. Thermal expansion characteristics of cordierite materials fired without boron oxide additive can be typically achieved for the corresponding boron oxide additive containing materials by firing at about 30-50 C lower firing temperature. The thermal expansion curves for both heating and cooling cycle for oxide batches (alumina, silica, magnesia) with boron oxide additive show only very small hysteresis, suggesting that no enhanced microcracking occurs during cooling. The amount of second phases in the fully fired materials is typically lower than 5%. The second phases in presence besides cordierite and indialite are sapphirine, spinel, mullite and glass.

Significant improvement of MOR is observed in presence of boron oxide sintering additive. MOR was measured on extruded 8 mm diameter rods and on 4 mm×4 mm×25 mm bars of the extruded 1″ diameter honeycomb with cell geometry 200/18 by 4-point flexure in an Instron machine.

The modulus of rupture of fully fired honeycomb is strongly improved when the boron oxide sinter additive is used. For 1″ honeycomb of geometry 200/18 obtained from A-batch without sintering additive fired at maximum temperatures between 1400 and 1430 C for 15 to 30 h, the room temperature MOR is 400-500 psi. For the same honeycomb geometry, the MOR of parts obtained with boron oxide sintering additive achieves in the best case triple that value, 1400 psi. Typically, the room temperature MOR varies between 900 and 1400 psi depending on the maximum firing temperature and firing time.

Example of the room temperature modulus of rupture of fully fired (1430 C, 15 h) A-batches containing 0, 0.3 and 1.5% boron oxide as sinter additive in an oxide batch: The MOR of the 8 mm rods increases with boron oxide batch addition from 950 psi for the boron-free oxide batch to 1100 psi for a batch containing about 0.3 percent sintering agent (boron oxide) to 1700 psi when prepared from a batch containing about 1.5 percent sintering agent (boron oxide) (firing at 1430 C for 15 h).

The strain tolerance of the fired parts obtained with boron oxide sintering additive is highly improved. Both MOR and E-modulus increase for materials obtained with boron oxide additive, but the increase in MOR over-compensates the increase in E-modulus. This is illustrated by the improved ratio of modulus of rupture and elastic modulus of parts obtained with the oxide raw material batch with boron oxide addition compared to the corresponding boron-free batch. For the example of an oxide batch fired at 1400° C., the strain tolerance MOR/E-modulus (room temperature data) is doubled for the material obtained with 2% boron oxide as sinter additive compared to the one obtained without boron oxide. The ratio between room temperature modulus of rupture and room temperature elastic modulus of the fully fired additive-free honeycomb and the honeycomb obtained under use of 2% B₂O₃ as sinter additive are 7.7×10⁻⁴ and 1.5×10⁻³, respectively.

The data suggest an additional contribution in the MOR related to the microstructure. The TEM observations presented in FIG. 4 reveal glass-free grain boundaries in fully sintered cordierite ceramics obtained with boron oxide sinter additive and suggest an improvement of the grain boundary fracture toughness compared to traditionally fired cordierite that typically contains glassy grain boundary films and small glass or oxide triple phase pockets or precipitates. Glassy grain boundary films and second phase pockets constitute sites for easier crack formation and thus have to be considered as limiting the materials strength. Comparison of traditionally fired cordierite (column A) and materials fired with increasing boron oxide additives (columns B-D) reveal lower dislocation densities and lower local stress concentrations in the latter materials via transmission electron microscopy. The presence of grain boundary dislocations in the materials obtained with boron oxide sinter additive confirms the absence of any glass film in the boundaries. In materials sintered in presence of boron, absolutely no glassy grain boundary films are seen, while in traditionally sintered batches, numerous c-facet grain boundaries are decorated with mixed alumino-silicate glass.

It will become apparent to those skilled in the art that various modifications to the preferred embodiment of the invention as described herein can be made without departing from the spirit or scope of the invention as defined by the appended claims.

The invention claimed is:

1. A process for making a cordierite ceramic article, comprising:
preparing a solution comprising a sintering promoting agent dissolved in a solvent;
mixing the solution, a magnesia source, an alumina source, a silica source, and an organic binder to obtain a plastic mixture in which the sintering promoting agent is homogeneously distributed;
shaping the plastic mixture to form a shaped article; and
heating the shaped article at a temperature and for a time effective to convert the shaped article to crystalline cordierite.

2. The process of claim 1, wherein the sintering promoting agent comprises from about 0.3 to about 5 percent of the plastic mixture on a dry basis.

3. The process of claim 1, wherein the maximum temperature during heating of the shape article is from about 1250° C. to about 1450° C.

4. The process of claim 1, wherein the maximum heating temperature is maintained for about 30 hours or less.

5. The process of claim 1, wherein a pore former is distributed in the plastic mixture before it is shaped.

6. The process of claim 5, wherein the pore former is particulate graphite present in an amount from about 10 to 40 percent of the weight of the plastic mixture.

7. The process of claim 6, wherein the pore former is starch present in an amount from about 10 to 20 percent of the weight of the plastic mixture.

8. The process of claim 1, wherein the plastic mixture is extruded through a die to form an extruded article of honeycomb form.

9. The process of claim 1, wherein the solvent is water, and the sintering promoting agent is boron oxide.

10. A plastic cordierite precursor composition, comprising:
a mixture comprising a magnesia source, an alumina source, a silica source, an organic binder, and a solution comprising a sintering promoting agent dissolved in a solvent.

11. The composition of claim 10, wherein the solution comprises from about 0.3 to about 5 percent sintering promoting agent by weight.

12. The composition of claim 10, further comprising a pore former distributed in the mixture.

13. The composition of claim 10, wherein the pore form in graphite present in an amount from about 10 to 40 percent of the weight of the composition.

14. The composition of claim 10, wherein the sintering promoting agent is boron oxide.

15. A crystalline cordierite article made by shaping and firing the composition of claim 10.

16. The article of claim 15, wherein the sintering promoting agent is boron oxide.

17. The article of claim 15, shaped by extrusion through a die into a honeycomb form.

18. The article of claim 15, having a CTE of about 5×10⁻⁷/K or less from 25° C. to 800° C.

19. The article of claim 15, having a porosity greater than 40 percent, an MOR of at least about 1100 psi, and having substantially no pores less than about 2 μm in diameter.

20. The article of claim 15, having residual boron content as determined by ICP analysis in the range of 0.05 to 1.8% boron.
